(19) United States
(12) Patent Application Publication
(10) Pub. No.: US 2022/0307876 A1
(43) Pub. Date: Sep. 29, 2022

(54) Physical Quantity Detection Device

(71) Applicant: Hitachi Astemo, Ltd., Hitachinaka-shi, Ibaraki (JP)

(72) Inventors: Masamichi NAKAMURA, Tokyo (JP); Akira UENODAN, Hitachinaka-shi (JP); Takahiro MIKI, Hitachinaka-shi (JP); Nobuaki GORAI, Hitachinaka-shi (JP); Naoki SAITO, Hitachinaka-shi (JP); Takayuki ISHIKAWA, Hitachinaka-shi (JP)

(21) Appl. No.: 17/595,251

(22) PCT Filed: Jun. 12, 2020
(86) PCT No.: PCT/JP2020/023150

§ 371 Date: Nov. 12, 2021

(30) Foreign Application Priority Data
Jun. 25, 2019 (JP) 2019-117082

(51) Int. Cl. G01F 1/40

(52) U.S. Cl. CPC G01F 1/40

(57) ABSTRACT

In the physical quantity detection device, the occurrence of the measurement error is reduced by suppressing the flow bias in the sub-passage and reducing the resistance in the passage. A physical quantity detection device 30 of the present invention includes a measuring portion 310 disposed in a main passage, a sub-passage 330 that takes a gas to be measured from the main passage, a support member 603 that divides a part of the sub-passage into two flow paths of one surface side and the other surface side in a direction intersecting a passage width direction, and a flow rate detection element 602 disposed on one surface of the support member. The sub-passage includes a straight portion 321 in which the support member is disposed and a downstream curved portion 322 that is curved to one side in the passage width direction of the straight portion. The straight portion is provided with a dividing wall 500 that divides the flow path on the other surface side of the support member into two flow paths on one side and the other side in the passage width direction, and a cross-sectional area of the flow path on one side in the passage width direction is smaller than a cross-sectional area of the flow path on the other side in the passage width direction.

### TECHNICAL FIELD

The present invention relates to a physical quantity detection device that detects a physical quantity of intake air of an internal combustion engine, for example.

### BACKGROUND ART

For example, PTL 1 discloses a configuration of a physical quantity detection device in which a measuring portion protrudes from an inner wall of an intake passage toward a passage center, a sub-passage for taking in a flow is disposed in the measuring portion, and a flow rate detection element is disposed so as to straddle the curved sub-passage. In the physical quantity detection device described above, a plate-like member for protecting the detection element is installed on the upstream side of the detection element, and the detection element is protected from contaminants flowing into the sub-passage. At this time, since the speed of the flow passing through the detection element decreases, there has been proposed a physical quantity detection device that increases the flow velocity by installing a resistance member in a passage divided by a support portion of the detection element.

### CITATION LIST

### Patent Literature

PTL 1: JP 2003-315116 A

### SUMMARY OF INVENTION

### Technical Problem

In the configuration of PTL 1, although the resistance members are installed in the sub-passage in order to increase the flow velocity in the vicinity of the detection element, the resistance members are symmetrically installed, and only a simple acceleration effect is obtained in the vicinity of the detection element, and the flow velocity distribution in the entire passage is not taken into consideration. Therefore, in some cases, there is a possibility that the pressure loss in the passage increases, the flow velocity in the passage decreases, and the flow rate of a gas to be measured decreases, and there is a concern that errors change according to pulsation conditions, and detection accuracy decreases.

The present invention has been made in view of the above points, and an object of the present invention is to provide a physical quantity detection device capable of optimizing a flow velocity distribution in a sub-passage and preventing variations in errors under a plurality of pulsation conditions.

### Solution to Problem

There is provided a physical quantity detection device that detects a physical quantity of a gas to be measured flowing in a main passage, the physical quantity detection device including: a measuring portion disposed in the main passage; a sub-passage provided in the measuring portion and configured to take the gas to be measured from the main passage; a support member that extends over a passage width direction of the sub-passage in a middle of the passage of the sub-passage and divides a part of the sub-passage into two flow paths on one surface side and the other surface side in a direction intersecting the passage width direction; and a flow rate detection element that is disposed on one surface of the support member and detects a flow rate of the gas to be measured in the sub-passage, wherein the sub-passage includes a straight portion that extends linearly and on which the support member is disposed, and a downstream curved portion that is continuous with a downstream side of the straight portion and curves toward one side in the passage width direction of the straight portion, the straight portion is provided with a dividing wall that divides the flow path on the other surface side of the support member into two flow paths on one side and the other side in the passage width direction, and among the two flow paths on one side and the other side in the passage width direction divided by the dividing wall, a cross-sectional area of the flow path on one side in the passage width direction is smaller than a cross-sectional area of the flow path on the other side in the passage width direction.

### Advantageous Effects of Invention

According to the present invention, it is possible to optimize the flow velocity distribution in the sub-passage and to prevent variations in errors in a plurality of pulsation conditions. Further features related to the present invention will become apparent from the description of the present specification and the accompanying drawings. Problems, configurations, and effects other than those described above will be clarified by the following description of embodiments.

### BRIEF DESCRIPTION OF DRAWINGS

FIG. 1 is a system diagram illustrating an embodiment in which a physical quantity detection device according to the present invention is used in an internal combustion engine control system.

FIG. 2 is a front view schematically illustrating a structure of a physical quantity detection device according to a first embodiment.

FIG. 3 is a cross-sectional view taken along line Q-Q in FIG. 2.

FIG. 4A is a schematic view of a flow velocity distribution on an intersection line of a cross section taken along line P-P in FIG. 2 and a cross section taken along line S-S in FIG. 3 in a case where no dividing wall is provided.

FIG. 4B is a diagram for explaining a pressure state when a gas to be measured having the flow velocity distribution illustrated in FIG. 4A flows into a downstream curved portion.

FIG. 5A is a schematic view of a flow velocity distribution in a sub-passage in a cross section taken along line Q-Q in FIG. 2 and a cross section taken along line S-S in FIG. 3 in a case where a dividing wall is provided.

FIG. 5B is a diagram for explaining a pressure state when a gas to be measured having the flow velocity distribution illustrated in FIG. 5A flows into a downstream curved portion.

FIG. 6 is a front view schematically illustrating a structure of a physical quantity detection device according to a second embodiment.

FIG. 7 is a cross-sectional view taken along line R-R in FIG. 6.

FIG. 8 is a front view schematically illustrating a structure of a physical quantity detection device according to a third embodiment.

FIG. 9 is a front view schematically illustrating a structure of a physical quantity detection device according to a fourth embodiment.

### DESCRIPTION OF EMBODIMENTS

A mode for carrying out the invention (hereinafter, embodiments) described below solves various problems desired as an actual product, and solves various problems desirable for use as a detection device that detects a physical quantity of intake air of a vehicle in particular, and exhibits various effects. One of various problems solved by the following embodiments is the content described in the section of the problem to be solved by the above-described invention, and one of various effects achieved by the following embodiments is the effect described in the section of the effect of the invention. Various problems solved by the following embodiments and various effects achieved by the following embodiments will be described in the following description of the embodiments. Therefore, the problems and effects solved by the embodiments described in the following embodiments are also described in contents other than the contents in the section of the problems to be solved by the invention and the section of the effects of the invention.

In the following embodiments, the same reference numerals indicate the same configuration even if the figure numbers are different, and the same functions and effects are obtained. For the already described configuration, only reference numerals are given to the drawings, and description thereof may be omitted.

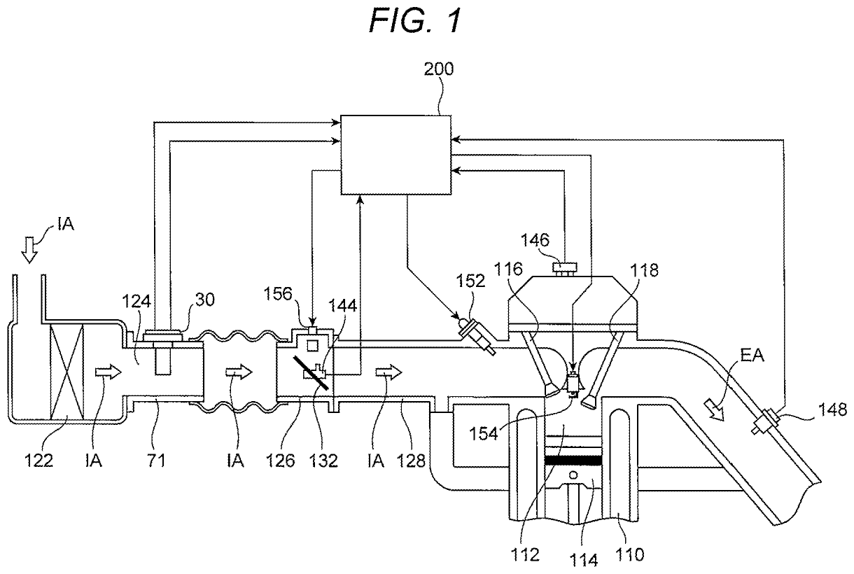

FIG. 1 is a system diagram illustrating an embodiment in which a physical quantity detection device according to the present invention is used in an internal combustion engine control system of an electronic fuel injection method.

Based on the operation of an internal combustion engine 110 including an engine cylinder 112 and an engine piston 114, intake air is taken in from an air cleaner 122 as a gas IA to be measured, and is guided to a combustion chamber of the engine cylinder 112 via, for example, an intake body which is a main passage 124, a throttle body 126, and an intake manifold 128. The physical quantity of the gas IA to be measured which is the intake air guided to the combustion chamber is detected by the physical quantity detection device 30 according to the present invention, fuel is supplied from a fuel injection valve 152 on the basis of the detected physical quantity, and the fuel and the gas IA to be measured are guided to the combustion chamber in a state of an air-fuel mixture. In the present embodiment, the fuel injection valve 152 is provided in an intake port of the internal combustion engine, and the fuel injected into the intake port forms an air-fuel mixture together with the gas IA to be measured, is guided to the combustion chamber via an intake valve 116, and burns to generate mechanical energy.

The fuel and the air guided to the combustion chamber are in a mixed state of the fuel and the air, and are explosively burned by spark ignition of an ignition plug 154 to generate mechanical energy. The gas after combustion is guided from an exhaust valve 118 to an exhaust pipe, and is discharged from the exhaust pipe to the outside of the vehicle as an exhaust gas EA. The flow rate of the gas IA to be measured, which is the intake air guided to the combustion chamber, is controlled by a throttle valve 132 whose an opening degree changes based on an operation of an accelerator pedal. The fuel supply amount is controlled based on the flow rate of the intake air guided to the combustion chamber, and a driver can control the mechanical energy generated by the internal combustion engine by controlling the opening degree of the throttle valve 132 to control the flow rate of the intake air guided to the combustion chamber.

The physical quantities such as a flow rate, temperature, humidity, and pressure of the gas IA to be measured, which is the intake air taken in from the air cleaner 122 and flowing through the main passage 124, are detected by the physical quantity detection device 30, and an electric signal representing the physical quantity of the intake air is input from the physical quantity detection device 30 to a control device 200. In addition, an output of a throttle angle sensor 144 that measures the opening degree of the throttle valve 132 is input to the control device 200, and further, an output of a rotational angle sensor 146 is input to the control device 200 in order to measure positions and states of the engine piston 114, the intake valve 116, and the exhaust valve 118 of the internal combustion engine, and a rotation speed of the internal combustion engine. In order to measure the state of the mixture ratio of a combustion amount and an air amount from the state of the exhaust gas EA, the output of an oxygen sensor 148 is input to the control device 200.

The control device 200 calculates a fuel injection amount and ignition timing based on the physical quantity of the intake air which is the output of the physical quantity detection device 30 and the rotation speed of the internal combustion engine measured based on the output of the rotational angle sensor 146. Based on these calculation results, the amount of fuel supplied from the fuel injection valve 152 and the ignition timing that the fuel is ignited by the ignition plug 154 are controlled. The fuel supply amount and the ignition timing are actually finely controlled based on a change state of a temperature and a throttle angle detected by the physical quantity detection device 30, a change state of an engine rotation speed, and a state of an air-fuel ratio measured by the oxygen sensor 148. The control device 200 further controls the amount of air bypassing the throttle valve 132 by an idle air control valve 156 in an idle operation state of the internal combustion engine, and controls the rotation speed of the internal combustion engine in the idle operation state.

Both the fuel supply amount and the ignition timing, which are main control amounts of the internal combustion engine, are calculated using the output of the physical quantity detection device 30 as a main parameter. Therefore, it is important to improve the detection accuracy of the physical quantity detection device 30, suppress the change with time, and improve the reliability for improving the control accuracy of the vehicle and securing the reliability.

In particular, in recent years, demands for fuel saving of vehicles are very high, and demands for exhaust gas purification are very high. In order to meet these demands, it is extremely important to improve the detection accuracy of the physical quantity of the intake air (gas IA to be measured) detected by the physical quantity detection device 30. It is also important that the physical quantity detection device 30 maintains high reliability.

The vehicle on which the physical quantity detection device 30 is mounted is used in an environment where changes in temperature and humidity are large. It is desirable that the physical quantity detection device 30 consider a response to a change in temperature or humidity in the use environment and a response to dust, contaminants, and the like.

The physical quantity detection device 30 is mounted on the intake pipe affected by heat generated from the internal combustion engine. Therefore, heat generated by the internal combustion engine is transmitted to the physical quantity detection device 30 via the intake pipe which is the main passage 124. Since the physical quantity detection device 30 detects the flow rate of the gas IA to be measured by performing heat transfer with the gas IA to be measured, it is important to suppress the influence of heat from the outside as much as possible.

As described below, the physical quantity detection device 30 mounted on the vehicle not only simply solves the problem described in the section of the problem to be solved by the invention and exerts the effect described in the section of the effect of the invention, but also solves various problems required as a product in sufficient consideration of the various problems described above and exerts various effects. Specific problems to be solved and specific effects to be obtained by the physical quantity detection device 30 will be described in the following description of the embodiment.

### First Embodiment

Hereinafter, a first embodiment of the present invention will be described with reference to the drawings.

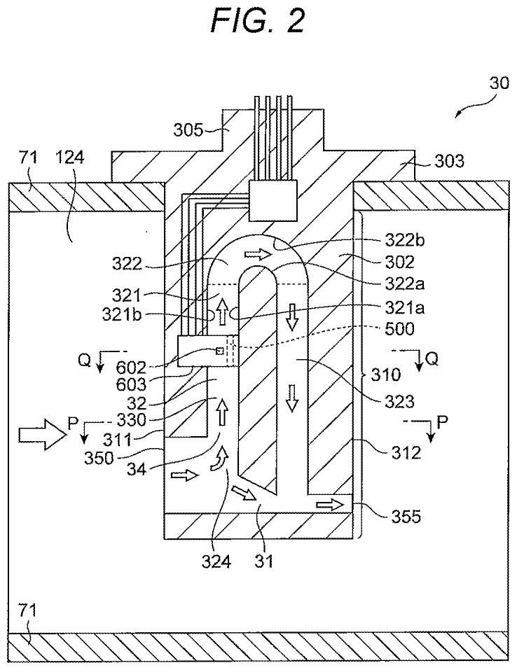

FIG. 2 is a front view schematically illustrating a structure of a physical quantity detection device 30.

The physical quantity detection device 30 includes a housing 302. The housing 302 includes a flange 303 for fixing the physical quantity detection device 30 to an intake body 71 constituting the main passage 124, an external connection portion (connector portion) 305 having an external terminal for electrical connection with an external device, and a measuring portion 310 for measuring a flow rate or the like. In the physical quantity detection device 30, the flange 303 is fixed to the intake body (intake pipe) 71, so that the measuring portion 310 is disposed in the main passage 124 and supported in a cantilever manner.

The measuring portion 310 disposed in the main passage 124 is provided with a sub-passage 330 that takes the gas IA to be measured from the main passage 124. A support member 603 is disposed in the middle of the sub-passage 330. The support member 603 has a flat plate shape, extends in a passage width direction W of the sub-passage in the middle of the sub-passage, and divides a part of the sub-passage into two flow paths on a front surface 603a side (one surface side) and a back surface 603b side (the other surface side) which are directions intersecting with the passage width direction. A flow rate detection element 602 for measuring the flow rate of the gas IA to be measured flowing through the main passage 124 is provided on the surface of the support member 603. Examples of the support member include a circuit package and a printed board.

The sub-passage 330 includes a first sub-passage 31 and a second sub-passage 32. The first sub-passage 31 is a passage formed from the main intake port 350 for taking the gas IA to be measured flowing through the main passage 124 to a main outlet 355 for discharging the taken gas IA to be measured. Here, a case where the gas IA to be measured is a forward flow is illustrated. The second sub-passage 32 is a flow rate measuring passage formed from a sub-intake port 34 through which the gas IA to be measured flowing in the first sub-passage 31 is taken toward the flow rate detection element 602. The sub-passage 330 allows foreign matters such as dust and water to mainly flow into the first sub-passage 31, and allows clean air not containing these foreign matters to be taken into the second sub-passage 32.

The gas IA to be measured taken into the sub-passage 330 from a main intake port 350 is divided to the first sub-passage 31 and the second sub-passage 32. The gas IA to be measured flowing through the second sub-passage 32 passes through the flow rate detection element 602, then flows into the first sub-passage 31, merges with the gas IA to be measured flowing through the first sub-passage 31, and is discharged from the main outlet 355.

The first sub-passage 31 is provided in the measuring portion 310 so as to extend in parallel along the flow direction of the gas IA to be measured flowing through the intake body 71 in a state of being attached to the intake body 71.

The main intake port 350 and the main outlet 355 are provided on the distal end side of the measuring portion 310, respectively, the main intake port 350 is open to the upstream end portion 311 of the measuring portion 310 disposed upstream in the main passage 124, and the main outlet 355 is open to the downstream end portion 312 of the measuring portion 310 disposed downstream in the main passage 124.

The second sub-passage 32 branches from the first sub-passage 31 at a sub-intake port 34 opened at a midway position of the first sub-passage 31, and extends from a distal end portion toward a proximal end portion of the measuring portion 310. Then, the second sub-passage is curved in a direction approaching the downstream end portion 312 of the measuring portion 310 in the vicinity of the proximal end portion, extends again from the proximal end portion toward the distal end portion of the measuring portion 310, and joins the first sub-passage 31.

The second sub-passage 32 includes a first straight portion (straight portion) 321 which extends linearly from the sub-intake port 34 toward the proximal end portion of the measuring portion 310 and in which the support member 603 is disposed at a midway position thereof, a downstream curved portion 322 which is continuous to the downstream side of the first straight portion 321 and curved to one side in the passage width direction of the first straight portion 321, and a second straight portion 323 which extends linearly from the proximal end portion toward the distal end portion of the measuring portion 310 continuously to the downstream curved portion 322 and is connected to the first sub-passage 31.

The downstream curved portion 322 has a semicircular arc shape that curves with a constant curvature from the upstream end portion 311 side of the measuring portion 310 toward the downstream end portion 312 side, which is one side in the passage width direction of the first straight portion 321, and makes a U-turn. The downstream curved portion 322 has an inner peripheral side curved wall surface 322a having a large curvature on one side in the passage width direction and an outer peripheral side curved wall surface 322b having a small curvature on the other side in the passage width direction. The inner peripheral side curved wall surface 322a having a large curvature of the downstream curved portion 322 is continuous with the side wall surface 321a on one side in the passage width direction of the first straight portion 321, and the outer peripheral side curved wall surface 322b having a small curvature of the downstream curved portion 322 is continuous with the side wall surface 321b on the other side in the passage width direction of the first straight portion 321.

An upstream curved portion 324 is continuously provided on the upstream side of the first straight portion 321. The upstream curved portion 324 is provided between the sub-intake port 34 and the first straight portion 321, and has a shape curved from the first straight portion 321 to the other side in the passage width direction of the first straight portion 321, in the present embodiment, the upstream end portion 311 side of the measuring portion 310. The upstream curved portion 324 changes the direction of the gas IA to be measured taken into the sub-passage 330 from the main intake port 350 and flowing from the upstream end portion 311 toward the downstream end portion 312 of the measuring portion 310 to the direction from the distal end portion toward the proximal end portion of the measuring portion 310.

Next, a configuration in which the occurrence of the measurement error is reduced by suppressing the flow bias in the passage and suppressing the pressure loss according to the present embodiment will be described.

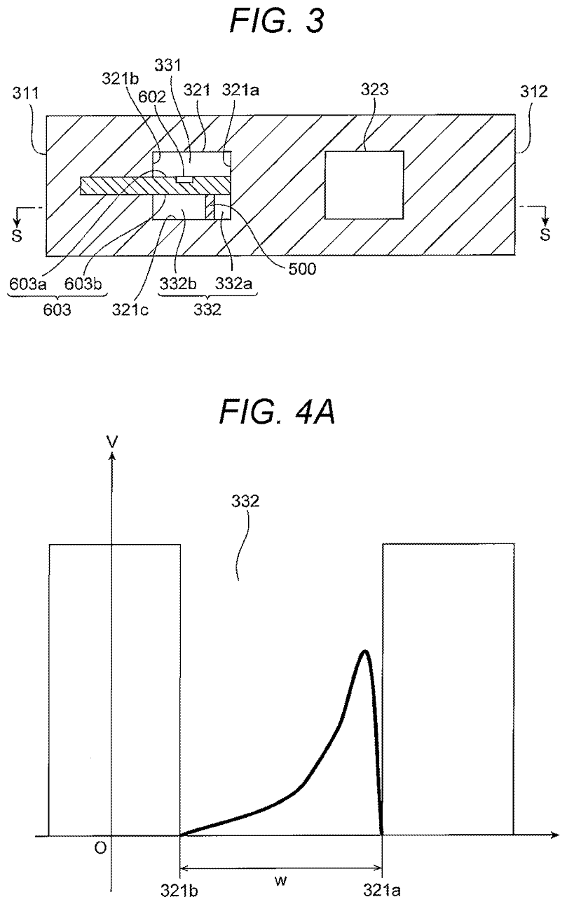

FIG. 3 is a cross-sectional view taken along line Q-Q in FIG. 2.

The first straight portion 321 of the second sub-passage 32 is divided into a surface flow path 331 on the surface 603a side of the support member 603 and a back surface flow path 332 on the back surface 603b side. The back surface flow path 332 is divided by a dividing wall 500 into an inner peripheral side passage 332a serving as a flow path on one side in the passage width direction and an outer peripheral side passage 332b serving as a flow path on the other side in the passage width direction. The back surface flow path 332 is divided such that the cross-sectional area of the inner peripheral side passage 332a is smaller than the cross-sectional area of the outer peripheral side passage 332b.

As illustrated in FIG. 3, the dividing wall 500 has a height enough to protrude toward the support member 603 from a bottom surface 321c of the first straight portion 321, which is the bottom surface of the sub-passage 330 facing the back surface (other surface) 603b of the support member 603, and to abut on the other surface 603b of the support member 603. The dividing wall 500 is formed integrally with the measuring portion 310, and also functions as a member that positions and supports the position of the support member 603 in the sub-passage 330. The dividing wall 500 is disposed at a position biased toward the downstream end portion 312 of the measuring portion 310, which is one side in the passage width direction with respect to the center position in the passage width direction of the back surface flow path 332, and divides the back surface flow path 332 so that the cross-sectional area of the inner peripheral side passage 332a is smaller than the cross-sectional area of the outer peripheral side passage 332b.

The dividing wall 500 may have the same length as or slightly shorter than the length in the flow direction of the fluid flowing through the sub-passage 330 of the support member 603, and has a size hidden behind the back surface 603b of the support member 603 when the physical quantity detection device 30 is viewed from the front side as illustrated in FIG. 2. In the present embodiment, the dividing wall 500 extends along the first straight portion 321 and has a length from the upstream end portion to the downstream end portion of the support member 603. That is, the upstream end portion of the dividing wall 500 disposed on the upstream side of the first straight portion 321 is disposed at the same position as the upstream end portion of the support member 603, and the downstream end portion of the dividing wall 500 disposed on the downstream side of the first straight portion 321 is disposed at the same position as the downstream end portion of the support member 603.

The length of the dividing wall 500 may be shorter than the length from the upstream end portion to the downstream end portion of the support member 603. For example, the upstream end portion of the dividing wall 500 may be disposed at a position on the downstream side of the first straight portion 321 with respect to the upstream end portion of the support member 603, and the downstream end portion of the dividing wall 500 may be disposed at a position on the upstream side of the first straight portion 321 with respect to the downstream end portion of the support member 603.

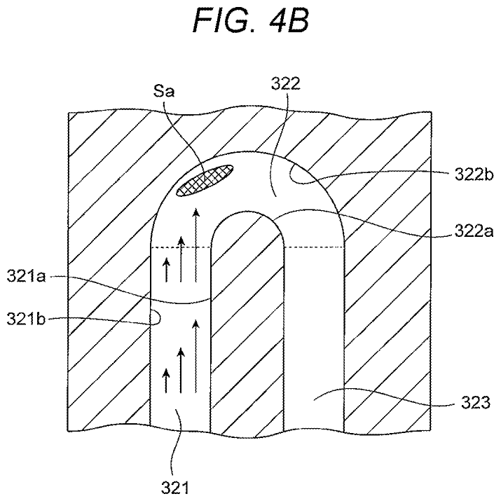

FIG. 4A is a schematic view of a flow velocity distribution on an intersection line of a cross section taken along line P-P in FIG. 2 and a cross section taken along line S-S in FIG. 3 in a case where no dividing wall is provided, and FIG. 4B is a diagram for explaining a pressure state when a gas to be measured having the flow velocity distribution illustrated in FIG. 4A flows into a downstream curved portion.

In the known case where the dividing wall 500 is not provided in the back surface flow path 332, the flow velocity distribution of the gas IA to be measured is not optimized in the first straight portion 321 of the second sub-passage 32. Therefore, for example, as illustrated in FIG. 4A, a peak of the flow velocity distribution may be biased toward the side wall surface 321a on one side in the passage width direction of the first straight portion 321 from the side wall surface 321b on the other side in the passage width direction of the first straight portion 321. In particular, in a case where the upstream curved portion 324 is continuously provided on the upstream side of the first straight portion, the gas IA to be measured taken from the main intake port 350 flows into the second sub-passage 32 from the first sub-passage 31 while changing the direction, so that the centrifugal force acts on the gas IA to be measured, the flow velocity is faster on one side in the passage width direction than on the other side in the passage width direction, and the flow velocity distribution tends to be biased to the side wall surface 321a side which is one side in the passage width direction of the first straight portion 321.

When the gas IA to be measured in which the flow velocity distribution is biased toward the side wall surface 321a on one side in the passage width direction of the first straight portion 321 flows into the downstream curved portion 322 as it is, the flow velocity component colliding with the outer peripheral side curved wall surface 322b having a small curvature of the downstream curved portion 322 is large, and as illustrated in FIG. 4B, there is a possibility that a high-pressure region Sa in which the pressure locally increases at the downstream curved portion 322 due to the collision to increase the pressure is generated. The generation of the high-pressure region Sa increases the flow resistance in the passage, makes the gas IA to be measured difficult to flow, decreases the flow rate in the passage of the second sub-passage 32, and increases the generation of the measurement error due to the decrease in the detection flow rate of the flow rate detection element 602. Therefore, the error changes according to the pulsation condition, and the detection accuracy may decrease.

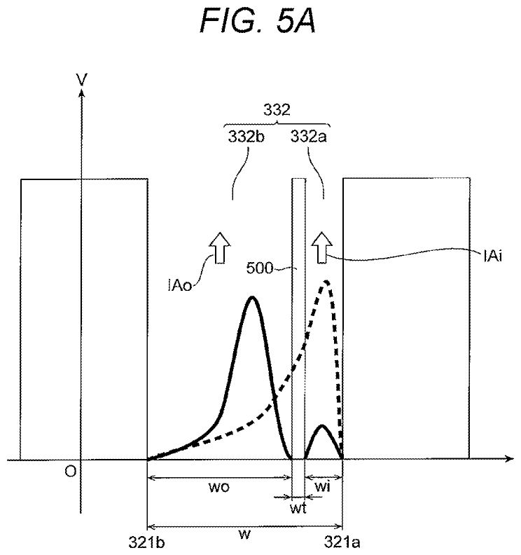

FIG. 5A is a schematic view of a flow velocity distribution on an intersection line of a cross section taken along line P-P in FIG. 2 and a cross section taken along line S-S in FIG. 3 in a case where no dividing wall is provided, and FIG. 5B is a diagram for explaining a pressure state when a gas to be measured having the flow velocity distribution illustrated in FIG. 5A flows into a downstream curved portion.

On the other hand, in the present embodiment, the dividing wall 500 is provided in the back surface flow path 332, and the dividing wall 500 is disposed at a position biased toward the side wall surface 321a which is one side in the passage width direction with respect to the center position in the passage width direction of the first straight portion 321. The back surface flow path 332 is divided into an inner peripheral side passage 332a and an outer peripheral side passage 332b by the dividing wall 500, and the inner peripheral side passage 332a has a smaller cross-sectional area than that of the outer peripheral side passage 332b. In the present embodiment, a passage width wi of the inner peripheral side passage 332a of the back surface flow path 332 is narrower than a passage width wo of the outer peripheral side passage 332b. The passage width wo of the outer peripheral side passage 332b is larger than a width wt of the dividing wall 500.

With this configuration, the gas IA to be measured passing through the back surface flow path 332 is less likely to flow in the inner peripheral side passage 332a than in the outer peripheral side passage 332b, and in the gas IA to be measured passing through the back surface flow path 332, a part of the gas IA to be measured passing through the side wall surface 321a which is one side in the passage width direction of the first straight portion 321 is partially biased toward the side wall surface 321b which is the other side in the passage width direction of the first straight portion 321. Therefore, a flow rate IAo flowing through the outer peripheral side passage 332b is larger than a flow rate IAi flowing through the inner peripheral side passage 332a. As a result, for example, when the flow velocity distribution of the gas IA to be measured flowing into the first straight portion 321 is biased toward the side wall surface 321a which is one side in the passage width direction of the first straight portion 321 as illustrated in FIG. 4A, a peak of the flow velocity distribution can be moved to the center position in the passage width direction of the back surface flow path 332 as illustrated in FIG. 5A.

When the gas IA to be measured whose the flow velocity distribution has moved to the side wall surface 321b side which is the other side in the passage width direction of the first straight portion 321 flows into the downstream curved portion 322, as illustrated in FIG. 5B, the gas IA to be measured is gently biased along the outer peripheral side curved wall surface 322b having a small curvature of the downstream curved portion 322. Therefore, as compared with the known structure in which the dividing wall 500 is not provided in the back surface flow path 332, the flow velocity component colliding with the outer peripheral side curved wall surface 322b of the downstream curved portion 322 is reduced, a pressure increase is reduced, the resistance of the curved portion is reduced, and the gas IA to be measured easily flows into the sub-passage 32. Therefore, the flow rate of the gas IA to be measured in the passage of the second sub-passage 32 is increased, and the occurrence of the measurement error is reduced by the increase in the detection flow rate of the flow rate detection element 602.

According to the physical quantity detection device 30 of the present embodiment, it is possible to reduce the pressure increase in the downstream curved portion 322 and the pressure loss accompanying the pressure increase. Therefore, even in a case where the flow rate of the gas IA to be measured in the main passage 124 is low and the inflow amount of the gas IA to be measured into the sub-passage 330 decreases, or in a case where the flow rate of the gas IA to be measured in the main passage 124 is high and the inflow amount of the gas IA to be measured into the sub-passage 330 decreases due to the pressure loss in the downstream curved portion 322 in the sub-passage 330 as in the known shape, the flow rate can be stably detected.

In the present embodiment, the inner peripheral side passage 332a of the back surface flow path 332 is not completely closed, and a fluid having a large flow velocity on the side wall surface 321a side, which is one side in the passage width direction of the first straight portion 321, can pass through the back surface flow path 332 as it is. For example, if a resistance member having a simple throttle shape is provided to reduce the cross-sectional area of the entire back surface flow path 332, all the portions having a high flow velocity of the gas IA to be measured passing through one side in the passage width direction of the back surface flow path 332 are biased and decelerated, the pressure increase of the back surface flow path 332 increases, and the resistance in the passage increases instead. On the other hand, as in the present embodiment, if the divided passage is divided by the dividing wall 500, the pressure increase of the back surface flow path 332 can also be prevented, and the resistance in the passage is reduced.

In the physical quantity detection device 30 of the present embodiment, the sub-passage 330 includes the first straight portion 321 that extends linearly and on which the support member 603 is disposed, and the downstream curved portion 322 which is continuous to the downstream side of the first straight portion 321 and curved to one side in the passage width direction of the first straight portion 321, the first straight portion 321 is provided with the dividing wall 500 that divides the back surface flow path 332 of the support member 603 into two flow paths, that is, the inner peripheral side passage 332a on one side and the outer peripheral side passage 332b on the other side in the passage width direction, and among the inner peripheral side passage 332a and the outer peripheral side passage 332b divided by the dividing wall 500, a cross-sectional area of the inner peripheral side passage 332a is smaller than a cross-sectional area of the outer peripheral side passage 332b.

According to the present embodiment, the dividing wall 500 is provided in the back surface flow path 332, and the cross-sectional area of the inner peripheral side passage 332a of the back surface flow path 332 is smaller than the cross-sectional area of the outer peripheral side passage 332b, so that the flow bias in the first straight portion 321 is suppressed, the flow rate distribution is optimized, and the resistance in the passage in the downstream curved portion 322 is reduced. As a result, the flow rate in the sub-passage increases, the flow rate detected by the flow rate detection element 602 increases, and the occurrence of the measurement error is reduced. Therefore, it is possible to optimize the flow velocity distribution in the sub-passage and to prevent variations in errors in a plurality of pulsation conditions.

In the physical quantity detection device 30 of the present exemplary embodiment, dividing wall 500 is provided only in the back surface flow path 332, and is not provided on the surface flow path 331 side. More specifically, the dividing wall 500 has a height enough to protrude toward the support member 603 from the bottom surface 321c of the sub-passage facing the back surface 603b of the support member 603 and abut on the back surface 603b of the support member 603, and does not protrude toward the front surface 603a of the support member 603 in the first straight portion 321.

Therefore, the dividing wall 500 does not cause disturbance such as a vortex flow with respect to the gas IA to be measured flowing through the surface flow path 331 of the support member 603, and it is possible to prevent the influence on the detection accuracy of the flow rate detection element 602 disposed on the surface 603a of the support member 603. Further, by bringing the dividing wall 500 into contact with the back surface 603b of the support member 603, the position of the support member 603 in the sub-passage 330 can be positioned, and an individual difference in the flow path area between the surface flow path 331 and the back surface flow path 332 can be eliminated.

The physical quantity detection device 30 of the present embodiment can increase the flow rate toward the flow rate detection element 602 in the sub-passage 330, optimize the deviation of the flow velocity distribution existing on the upstream side with respect to the downstream curved portion 322, and reduce the flow velocity component colliding with the outer peripheral side curved wall surface 322b of the downstream curved portion 322. Therefore, the detection performance can be improved by suppressing the generation of the high-pressure region Sa in the downstream curved portion 322, reducing the pressure loss in the sub-passage 330, increasing the flow rate flowing into the sub-passage 330, and increasing the detection amount of the flow rate detection element 602.

### Second Embodiment

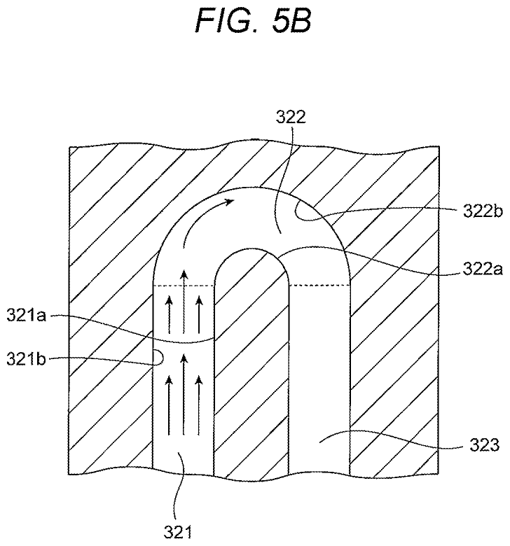

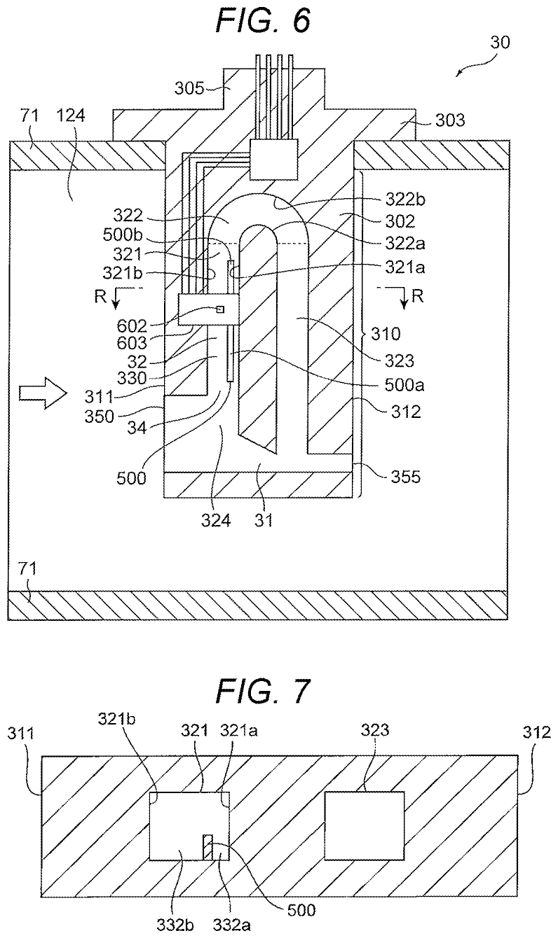

Next, a second embodiment according to the present invention will be described with reference to FIGS. 6 and 7. Note that configurations similar to those of the first embodiment are denoted by the same reference numerals, and a detailed description thereof will be omitted. FIG. 6 is a front view schematically illustrating a structure of a physical quantity detection device according to a second embodiment, and FIG. 7 is a schematic diagram of a cross section taken along line R-R in FIG. 6.

A characteristic feature of the present embodiment is that the dividing wall 500 that divides the back surface side passage of the flow rate detection element 602 is extended to the upstream side and the downstream side along the extending direction of the first straight portion 321, and has a long shape to be longer than the length of the support member 603 in the flow direction.

The height of the dividing wall 500 is constant from the upstream end portion to the downstream end portion, and as illustrated in FIG. 7, the height of the support member 603 in the direction of the flow rate detection element 602 does not change even at a position not on the back surface side of the support member. The dividing wall 500 has an upstream extension wall 500a extended toward the upstream of the first straight portion 321 from the support member 603 along the first straight portion 321, and a downstream extension wall 500b extended toward the downstream of the first straight portion 321 from the support member 603 along the first straight portion 321. The upstream extension wall 500a and the downstream extension wall 500b have the same height as a part dividing the back surface flow path 332 of the dividing wall 500.

According to the present embodiment, since the height of the dividing wall 500 does not reach the surface flow path 331 which is a passage on the surface 603a side of the support member 603, the flow of the gas IA to be measured passing through the flow rate detection element 602 is not disturbed.

Since the length of the dividing wall 500 is longer than that of the first embodiment, the flow bias in the first straight portion 321 can be further suppressed as compared with that in the first embodiment. Therefore, as compared with the first embodiment, the flow rate distribution of the gas IA to be measured in the second sub-passage 32 is optimized, the resistance in the passage in the downstream curved portion 322 is reduced, and the gas IA to be measured easily flows in the sub-passage 32. Therefore, the flow rate of the gas IA to be measured in the passage of the second sub-passage 32 is increased, and the occurrence of the measurement error is reduced by the increase in the detection flow rate of the flow rate detection element 602.

Therefore, it is possible to prevent the detection accuracy from deteriorating due to a change in the error according to the pulsation condition.

### Third Embodiment

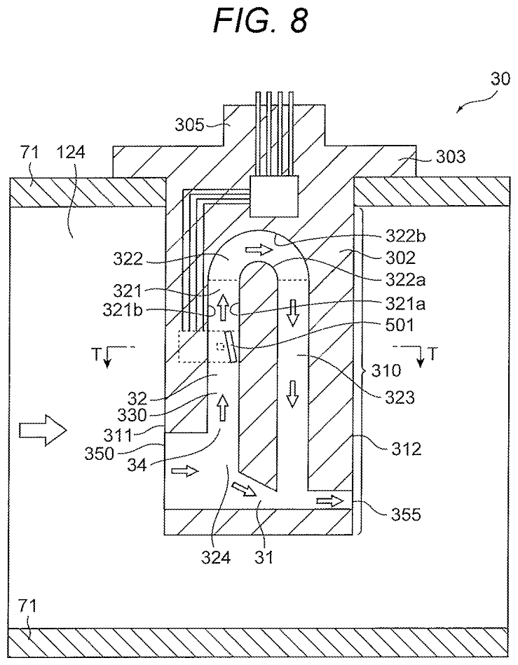

Next, a third embodiment according to the present invention will be described with reference to FIG. 8. Note that configurations similar to those of the above-described embodiments are denoted by the same reference numerals, and a detailed description thereof will be omitted.

FIG. 8 is a front view schematically illustrating a structure of a physical quantity detection device according to the third embodiment. FIG. 8 is a schematic view of the physical quantity detection device 30 viewed from a direction similar to those in FIGS. 2 and 6, and is a view on the S-S cross section illustrated in FIG. 3 as the cross section of the passage, which illustrates a cross section of the back surface flow path 332.

Therefore, the flow rate detection element 602 and the support member 603 are indicated by broken lines. In this drawing, the back surface flow path 332 is divided into an inner peripheral side passage 332a and an outer peripheral side passage 332b by a dividing wall 501.

A characteristic feature of the present embodiment is that the dividing wall 501 is provided to be inclined with respect to the first straight portion 321. Unlike the dividing wall 500 of the first embodiment, the dividing wall 501 is not provided in parallel with the flow direction of the first straight portion 321. The dividing wall 501 is inclined obliquely with respect to the first straight portion 321 such that the cross-sectional area of the inner peripheral side passage 332a gradually increases or decreases as the first straight portion 321 shifts from the upstream side to the downstream side.

When the downstream side is viewed from a T-T cross section in FIG. 8, the minimum portion of the cross-sectional area of the inner peripheral side passage 332a is smaller than the minimum portion of the cross-sectional area of the outer peripheral side passage 332b. In the present embodiment, the inner peripheral side passage 332a has a narrow passage cross-sectional area on the upstream side and a wide passage cross-sectional area on the downstream side with respect to the flow direction of the gas IA to be measured in the first straight portion 321. The inner peripheral side passage 332a may have a wide passage cross-sectional area on the upstream side and a narrow passage cross-sectional area on the downstream side with respect to the flow direction.

According to the present embodiment, similarly to the first embodiment, the gas IA to be measured flowing in the vicinity of the inner peripheral side passage 332a is biased to the outer peripheral side, and the component of the gas IA to be measured colliding with the downstream curved portion 322 is reduced. Therefore, the resistance in the passage is reduced, and the detection flow rate of the flow rate detection element 602 is increased, so that the occurrence of the measurement error is reduced.

### Fourth Embodiment

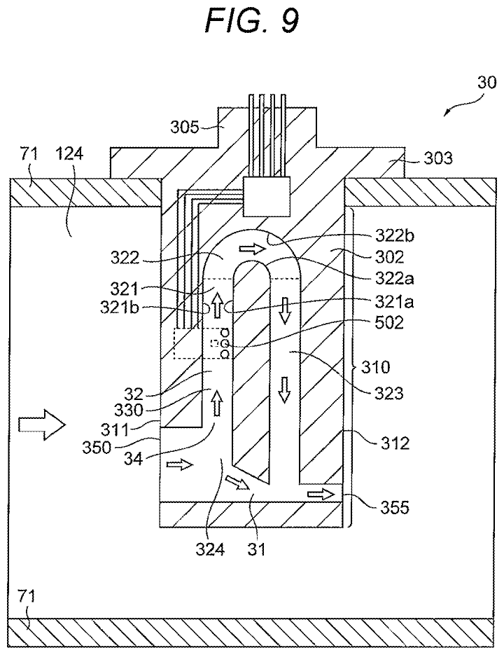

Next, a fourth embodiment according to the present invention will be described with reference to FIG. 9. Note that configurations similar to those of the above-described embodiments are denoted by the same reference numerals, and a detailed description thereof will be omitted.

FIG. 9 is a front view schematically illustrating a structure of a physical quantity detection device according to the fourth embodiment. FIG. 9 is a schematic view of the physical quantity detection device 30 viewed from a direction similar to those in FIG. 8, and is a view on the S-S cross section illustrated in FIG. 3 as the cross section of the passage, which illustrates a cross section of the back surface flow path 332. Therefore, the flow rate detection element 602 and the support member 603 are indicated by broken lines. A characteristic feature of the present embodiment is that an obstacle 502 is disposed in the back surface flow path 332 instead of the dividing walls 500 and 501 in each of the above-described embodiments, and the back surface flow path 332 is divided into the inner peripheral side passage 332a and the outer peripheral side passage 332b by the obstacle 502.

The obstacle 502 is made of three bar-shaped members, and is arranged side by side at a predetermined interval at a position that divides the back surface flow path 332 into the inner peripheral side passage 332a and the outer peripheral side passage 332b, similarly to the dividing wall 500 of FIG. 3, and at a position where the cross-sectional area of the inner peripheral side passage 332a of the back surface flow path 332 is smaller than the cross-sectional area of the outer peripheral side passage 332b. The number of obstacles is not limited to three in the present embodiment, and may be smaller or larger than three.

In the example illustrated in FIG. 9, the obstacle 502 is installed in a range smaller than the length of the flow direction of the support member 603 of the flow rate detection element 602, and is hidden by the support member 603 when viewed from the front side. However, the obstacle 502 may be installed in a range larger than the length of the flow direction of the support member 603. However, similarly to the dividing wall 500 of FIG. 7, the height of the obstacle 502 is lower than the surface 603a of the support member 603 and does not reach the surface flow path 331. In addition, in the example illustrated in FIG. 9, the plurality of obstacles 502 are arranged in parallel with the flow direction of the first sub-passage 31, but the plurality of obstacles may not be parallel with the flow direction.

The gas IA to be measured flowing through the back surface flow path 332 is biased from the inner peripheral side passage 332a to the outer peripheral side passage 332b by the obstacle 502, and is gently biased when the flow reaches the downstream curved portion 322. Therefore, the pressure increase at the downstream curved portion 322 is reduced, the resistance in the passage is reduced, the detection amount of the flow rate detection element 602 is increased, and the occurrence of the measurement error is reduced.

Although the embodiments of the present invention have been described in detail above, the present invention is not limited to the above embodiments, and various design changes can be made without departing from the gist of the present invention described in the claims. For embodiment, the above-described embodiments are described in detail in order to describe the present invention in an easy-to-understand manner, and are not necessarily limited to those having all the described configurations. Further, a part of the configuration of one embodiment can be replaced with the configuration of another embodiment, and the configuration of another embodiment can be added to the configuration of one embodiment. Furthermore, it is possible to add, delete, and replace other configurations for a part of the configuration of each embodiment.

### REFERENCE SIGNS LIST

30 physical quantity detection device
31 first sub-passage
32 second sub-passage
34 sub-intake port
302 housing
321 first straight portion
322 downstream curved portion
330 sub-passage
332a inner peripheral side passage
332b outer peripheral side passage
350 main intake port
355 main outlet
500, 501 dividing wall
502 obstacle (bar-shaped member)
602 flow rate detection element
603 support member

1. A physical quantity detection device that detects a physical quantity of a gas to be measured flowing in a main passage, the physical quantity detection device comprising:
a measuring portion disposed in the main passage;
a sub-passage provided in the measuring portion and configured to take the gas to be measured from the main passage;
a support member that extends over a passage width direction of the sub-passage in a middle of the passage of the sub-passage and divides a part of the sub-passage into two flow paths on one surface side and the other surface side in a direction intersecting the passage width direction; and
a flow rate detection element that is disposed on one surface of the support member and detects a flow rate of the gas to be measured in the sub-passage,
wherein the sub-passage includes a straight portion that extends linearly and on which the support member is disposed, and a downstream curved portion that is continuous with a downstream side of the straight portion and curves toward one side in the passage width direction of the straight portion,
the straight portion is provided with a dividing wall that divides the flow path on the other surface side of the support member into two flow paths on one side and the other side in the passage width direction, and
among the two flow paths on one side and the other side in the passage width direction divided by the dividing wall, a cross-sectional area of the flow path on one side in the passage width direction is smaller than a cross-sectional area of the flow path on the other side in the passage width direction.

2. The physical quantity detection device according to claim 1, wherein the dividing wall has a height enough to protrude toward the support member from a bottom surface of the sub-passage facing the other surface of the support member and abut on the other surface of the support member.

3. The physical quantity detection device according to claim 2,
wherein the dividing wall extends along the straight portion,
an upstream end portion of the dividing wall disposed on an upstream side of the straight portion is disposed at the same position as an upstream end portion of the support member or at a position on a downstream side of the straight portion with respect to the upstream end portion of the support member, and
the downstream end portion of the dividing wall disposed on a downstream side of the straight portion is disposed at the same position as a downstream end portion of the support member or at a position on an upstream side of the straight portion with respect to the downstream end portion of the support member.

4. The physical quantity detection device according to claim 2, wherein the dividing wall has an upstream extension wall extended toward the upstream of the straight portion from the support member along the straight portion, and a downstream extension wall extended toward the downstream of the straight portion from the support member along the straight portion.

5. The physical quantity detection device according to claim 1, wherein the dividing wall is disposed at a position biased toward one side in the passage width direction from a center position in the passage width direction of the sub-passage.

6. The physical quantity detection device according to claim 1, wherein in the dividing wall, a minimum portion of a cross-sectional area of a flow path on one side in the passage width direction is smaller than a minimum portion of a cross-sectional area of a flow path on the other side in the passage width direction.

7. The physical quantity detection device according to claim 1, wherein the dividing wall includes a plurality of bar-shaped members arranged side by side at predetermined intervals in an extending direction of the straight portion.

8. The physical quantity detection device according to claim 1, wherein the sub-passage includes an upstream curved portion that is continuous with an upstream side of the straight portion and is curved to the other side in a passage width direction of the straight portion.
